(19) United States
(12) Patent Application Publication
(10) Pub. No.: US 2007/0263794 A1
(43) Pub. Date: Nov. 15, 2007

(54) Method and apparatus for recording calls

(75) Inventor: John Mark F. Mocenigo, Califon, NJ (US)

Correspondence Address: AT&T CORP., ROOM 2A207, ONE AT&T WAY, BEDMINSTER, NJ, 07921, US

(73) Assignee: AT&T Corp.

(21) Appl. No.: 11/413,702

(22) Filed: Apr. 27, 2006

(51) Int. Cl. H04M 1/64

(52) U.S. Cl. 379/67.1

(57) ABSTRACT

A method and apparatus for providing a service for recording calls on packet networks such as Voice over Internet Protocol (VoIP) and Service over Internet Protocol (SoIP) networks are disclosed. In one embodiment, the service provider enables the customers or subscribers of the service to send a request to activate the service for recording calls, e.g., via a web access input, a touchtone signal, and/or in accordance with predefined preferences. Once activated, the service provider provides a method for announcing to the subscriber and/or at least one other participant that the call recording service has been invoked. The announcement is provided to solicit an acceptance from the at least one other participant of the recording of the call. If an acceptance is received to the recording, the service provider begins recording the call.

The present invention relates generally to communication networks and, more particularly, to a method for recording calls in packet networks such as Voice over Internet Protocol (VoIP) and Service over Internet Protocol (SoIP) networks.

### BACKGROUND OF THE INVENTION

The Internet has emerged as a critical communication infrastructure, carrying traffic for a wide range of important applications. Internet services such as VoIP and SoIP are becoming ubiquitous and more and more businesses and consumers are utilizing these networks to obtain services from any location with an Internet connection. For example, customers may combine their data and voice services on an Internet based infrastructure such as VoIP and access the services from any location with Internet access. However, VoIP customers have no capability to capture conversations and make the data available for the various services. For example, insurance adjusters may want the abilities to talk to clients, to record statements over the phone, to transfer the statements to text, and then to send the content for processing or storage. Since the conversation is not readily available in electronic format, dissemination of the conversation requires preprocessing by the insurance adjuster. The process becomes costly and lengthy.

Therefore there is a need for a method that enables the VoIP or SoIP service provider to provide a service for recording calls.

### SUMMARY OF THE INVENTION

In one embodiment, the present invention discloses a method and apparatus for providing a service for recording calls on packet networks such Voice over Internet Protocol (VoIP) and Service over Internet Protocol (SoIP) networks. The service provider enables the customers or subscribers of the service to send a request to activate the service for recording calls, e.g., via a web access input, a touchtone signal, and/or in accordance with predefined preferences. Once activated, the service provider provides a method for announcing to the subscriber and/or at least one other participant that the call recording service has been invoked. The announcement is provided to solicit an acceptance from the at least one other participant of the recording of the call. If an acceptance is received to the recording, the service provider begins recording the call.

### BRIEF DESCRIPTION OF THE DRAWINGS

The teaching of the present invention can be readily understood by considering the following detailed description in conjunction with the accompanying drawings, in which:

FIG. 1 illustrates an exemplary network related to the present invention;

FIG. 2 illustrates an exemplary network with one embodiment of the invention for providing service for recording calls;

FIG. 3 illustrates a flowchart of the method for providing service for recording calls; and

FIG. 4 illustrates a high-level block diagram of a general-purpose computer suitable for use in performing the functions described herein.

To facilitate understanding, identical reference numerals have been used, where possible, to designate identical elements that are common to the figures.

### DETAILED DESCRIPTION

The present invention broadly discloses a method and apparatus for providing a service for recording calls on networks such as VoIP or SoIP. Although the present invention is discussed below in the context of calls in VoIP and SoIP networks, the present invention is not so limited. Namely, the present invention can be applied for other networks such as cellular networks.

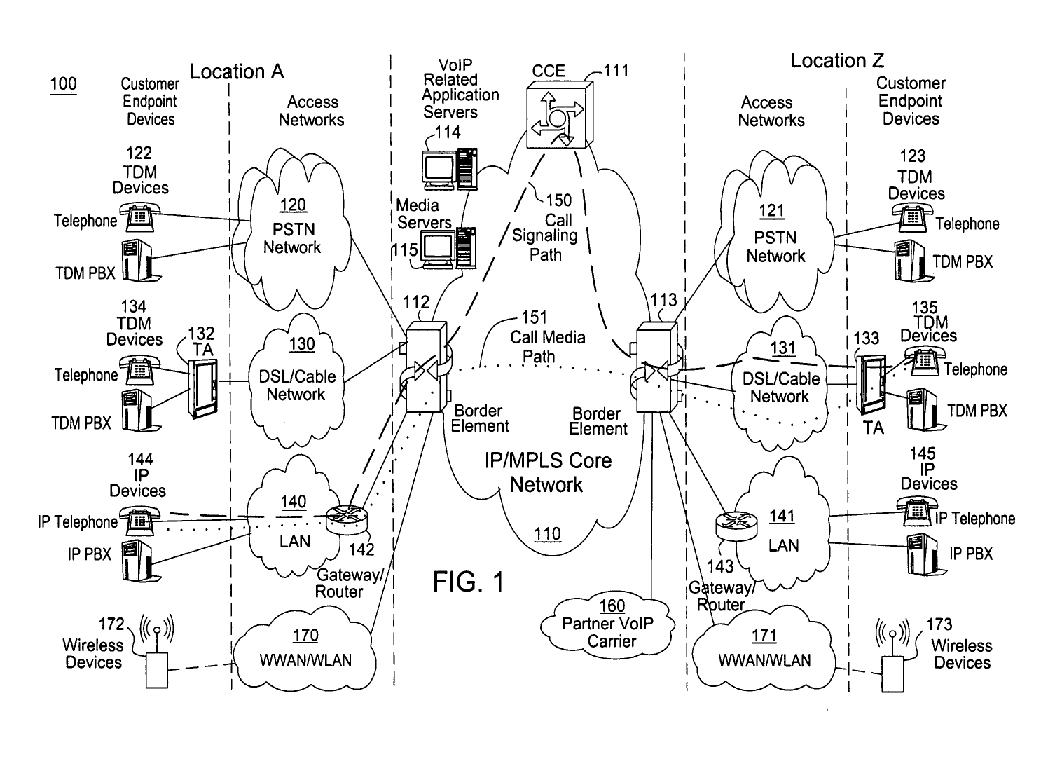

To better understand the present invention, FIG. 1 illustrates an example network 100, e.g., a packet network such as a VoIP network related to the present invention. Exemplary packet networks include Internet protocol (IP) networks, Asynchronous Transfer Mode (ATM) networks, frame-relay networks, and the like. An IP network is broadly defined as a network that uses Internet Protocol to exchange data packets. Thus, a VoIP network or a SoIP (Service over Internet Protocol) network is considered an IP network.

In one embodiment, the VoIP network may comprise various types of customer endpoint devices connected via various types of access networks to a carrier (a service provider) VoIP core infrastructure over an Internet Protocol/Multi-Protocol Label Switching (IP/MPLS) based core backbone network. Broadly defined, a VoIP network is a network that is capable of carrying voice signals as packetized data over an IP network. The present invention is described below in the context of an illustrative VoIP network. Thus, the present invention should not be interpreted as limited by this particular illustrative architecture.

The customer endpoint devices can be either Time Division Multiplexing (TDM) based, IP based or wireless such as cellular phones. TDM based customer endpoint devices 122, 123, 134, and 135 typically comprise of TDM phones or Private Branch Exchange (PBX). IP based customer endpoint devices 144 and 145 typically comprise IP phones or IP PBX. Wireless endpoint devices 172 and 173, typically comprise cellular phones, pocket PCs etc. The Terminal Adaptors (TA) 132 and 133 are used to provide necessary interworking functions between TDM customer endpoint devices, such as analog phones, and packet based access network technologies, such as Digital Subscriber Loop (DSL) or Cable broadband access networks. TDM based customer endpoint devices access VoIP services by using either a Public Switched Telephone Network (PSTN) 120, 121 or a broadband access network 130, 131 via a TA 132 or 133. IP based customer endpoint devices access VoIP services by using a Local Area Network (LAN) 140 and 141 which has a VoIP gateway router 142 or 143, as shown in FIG. 1. Wireless endpoint devices access VoIP services by using Wireless Local Area Networks (WLAN) or Wireless Wide Area Networks (WWAN) 170 and 171. The WLAN/WWAN networks 170 and 171 are connected to the IP core network 110 through the border elements 112 and 113, respectively.

The access networks for wired devices can be either TDM or packet based. A TDM PSTN 120 or 121 is used to support TDM customer endpoint devices connected via traditional phone lines. A packet based access network, such as Frame Relay, ATM, Ethernet or IP, is used to support IP based customer endpoint devices via a customer LAN, e.g., 140 with a VoIP gateway and router 142. A packet based access network 130 or 131, such as DSL or Cable, when used together with a TA 132 or 133, is used to support TDM based customer endpoint devices. The access networks 170 and 171 for wireless devices can be WLAN, WWAN or an integrated WLAN/WWAN networks.

The core VoIP infrastructure comprises of several key VoIP components, such as the Border Elements (BEs) 112 and 113, the Call Control Element (CCE) 111, VoIP related Application Servers (AS) 114, and Media Server (MS) 115. The BE resides at the edge of the VoIP core infrastructure and interfaces with customers endpoints over various types of access networks. A BE is typically implemented as a Media Gateway and performs signaling, media control, security, and call admission control and related functions. The CCE resides within the VoIP infrastructure and is connected to the BEs using the Session Initiation Protocol (SIP) over the underlying IP/MPLS based core backbone network 110. The CCE is typically implemented as a Media Gateway Controller or a softswitch and performs network wide call control related functions as well as interacts with the appropriate VoIP service related servers when necessary. The CCE functions as a SIP back-to-back user agent and is a signaling endpoint for all call legs between all BEs and the CCE. The CCE may need to interact with various VoIP related Application Servers (AS) in order to complete a call that requires certain service specific features, e.g. translation of an E.164 voice network address into an IP address and so on.

For calls that originate or terminate in a different carrier, they can be handled through the PSTN 120 and 121 or the Partner IP Carrier 160 interconnections. For originating or terminating TDM calls, they can be handled via existing PSTN interconnections to the other carrier. For originating or terminating VoIP calls, they can be handled via the Partner IP carrier interface 160 to the other carrier.

Media Servers (MS) 115 are special servers that typically handle and terminate media streams, and to provide services such as announcements, bridges, transcoding, and Interactive Voice Response (IVR) messages for VoIP service applications. The media servers also interact with customers for media session management to accomplish tasks such as process requests.

Note that a customer in location A using any endpoint device type with its associated access network type can communicate with another customer in location Z using any endpoint device type with its associated network type as well. For instance, a customer at location A using IP customer endpoint device 144 with packet based access network 140 can call another customer at location Z using TDM endpoint device 123 with PSTN access network 121. The BEs 112 and 113 are responsible for the necessary signaling protocol translation, e.g., SS7 to and from SIP, and media format conversion, such as TDM voice format to and from IP based packet voice format.

The above network is described to provide an illustrative environment in which services are provided on networks such as VoIP and SoIP networks. Internet services such as VoIP and SoIP are becoming ubiquitous and more and more businesses and consumers are utilizing these networks to obtain services. For example, customers may combine their data and voice services on an Internet based infrastructure such as VoIP and access the services from any location with Internet access. For example, voicemail service includes sending the voicemail messages to the customer via email. However, VoIP customers have no capability to capture conversations and make the data available for the various services. For example, insurance adjusters or lawyers may desire to have the capabilities to take statements over the phone, to transfer the statements to text format (e.g., generate transcripts of the conversation), and then to send the text files for processing or storage. Since the conversation is not readily available in electronic format, dissemination of the conversation requires preprocessing by the insurance adjuster or lawyer. The process becomes costly and lengthy. Therefore there is a need for a method that enables a service provider to provide a service for recording calls.

The current invention discloses a method and apparatus for providing a service for recording calls on networks such as VoIP or SoIP networks. The present invention enables the customer to have the recorded calls available for electronic dissemination. In order to clearly illustrate the teachings of the current invention, the following network terminologies will first be described:
Calling party;
Called party; and
Call Detail Recording.

Calling party refers to the person or device that originates the call. The called party refers to the person or device that receives the call. For example, if a person calls 911 for obtaining emergency service, the calling party is the person dialing 911 and the called party is the person or service answering the phone and receiving the 911 call.

Call Detail Recording refers to the creation of a database of Call Detail Records (CDR) in which call data on specific customer or group of telephone or IP addresses for a customer are collected and recorded. Each CDR may include details of the call such as the calling party, the called party, the source and destination addresses of the routers or switches handling the call, the time of the call, the duration of the call, the quality of service, disposition of the call including whether or not the called party was busy, the phone was ringing with no answer and the like. For example, if a customer accesses the VoIP core network through an access network, the customer then uses the VoIP network to transmit and receive packets. The CDR then includes the IP addresses of the calling and called parties, the time and duration of the call, the routers involved, disposition of the call and so on. The CDR can be used in many processes that create bills requiring payment for services, and so on. When a call is initiated by the calling party, the network service provider establishes the call and begins the process for gathering the data for the CDR.

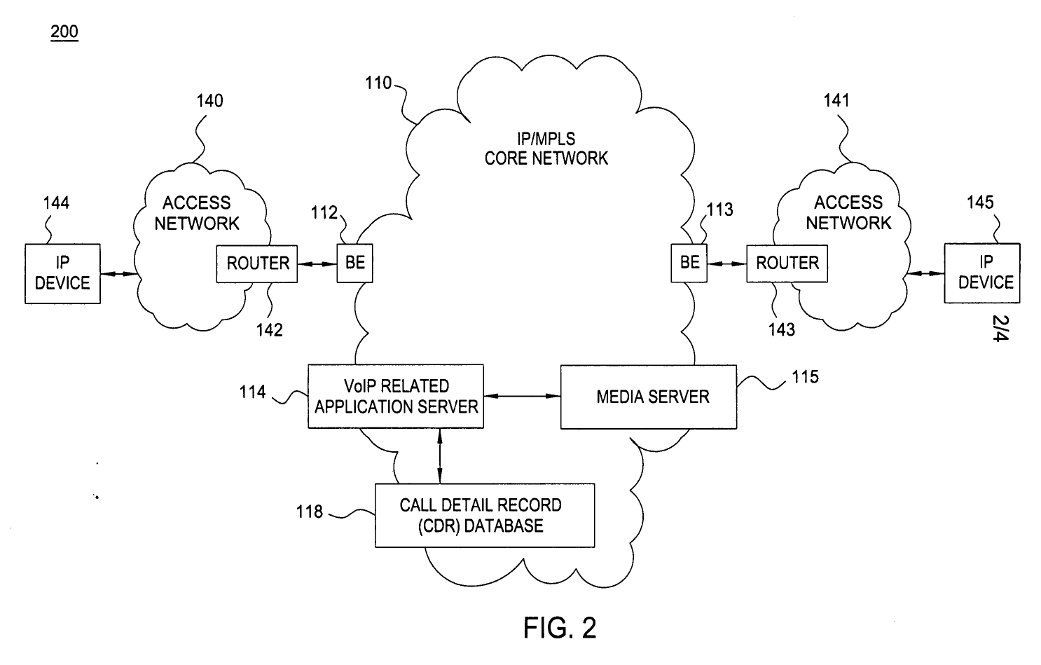

FIG. 2 illustrates an exemplary network 200 with one embodiment of the present invention for providing a service for recording calls. For example, the packets are exchanged between users of IP devices 144 and 145. The IP device 144 is deployed for accessing the VoIP or SoIP services through an access network 140. The packets transmitted by IP device 144 traverse the access network 140 towards the router 142. The router 142 is connected to an IP/MPLS core network 110 through a border element 112. Packets originated by the IP devices 144 traverse the core network 110 from border element 112 to border element 113. Border element 113 is connected to an access network 141 through a router 143. In turn, the packets from IP device 144 traverse through the access network 141 towards the IP device 145.

In one embodiment, an application server 114, e.g., a VoIP application server, located in the IP/MPLS core network 110 is utilized for providing a service for recording calls. The VoIP application server 114 is connected to a Call Detail Record (CDR) database 118, thereby allowing the application server to access Call Detail Records.

In one embodiment, the customer who is using one of the IP devices may subscribe to a call recording service and may have optionally provided preferences as to how recording of calls are to be implemented. For example, the preferences may include location for sending or storing the audio files, preferred action when service is invoked while a call is in progress, action(s) to be taken when the calling or called party refuses to be recorded, form of announcement to calling or called party, etc. In one embodiment, the service provider provides the service for recording calls by routing the calls via a path that includes the application server 114. The application server 114 processes requests for recording calls (e.g., invoking of service), and for terminating the recording. The application server 114 may also utilize a media server 115 for interacting with the called and/or calling parties to provide announcements of recording action, and to receive acknowledgements. The media server 115 is also used to notify the customer whether or not the calling or called party (the other participant on the call) has agreed to be recorded.

In one embodiment, the service provider determines the methods for invoking the service, e.g., via inputs received from a web interface, a touchtone or Dual Tone Multi Frequency (DTMF) signal that is provided during the call or prearranged prior to initiating the call, and so on. In one embodiment, the service provider enables the customer to invoke the service for call recording during the call. In another embodiment, the customer may invoke the service prior to receiving or originating call. If the customer's request for beginning the recording of calls is received while a call is in progress, then the server providing the call recording service is added to the route used for the voice packets. If the request for the recording of calls is received prior to the call, the route for the voice calls includes the server with the recording function.

In one embodiment, when the request for recording calls is received from the customer, the application server 114 determines the need for announcements and engages the media server 115 as needed. When the conversation is completed, the application server 114 forwards the audio file to the location provided by the customer. For example, the customer may specify an email address for sending the audio files. In another example, the customer may specify a memory location for storing the audio files. The customer may then access the audio files when needed. The CDR is updated when the service is initiated and terminated to facilitate operations functions such as billing. For example, if the customer's request for recording calls is received while a call is in progress, the CDR is updated to reflect the change in routing of voice packets to include the application server 114.

Those skilled in the art will realize that the above embodiment illustrates only one implementation of the present invention and it is not intended to limit the present invention. For example, multiple application servers and media servers may be used for interacting with the calling party and called party, for initiating and terminating recording, for sending the audio files to the customer, etc. Those skilled in the art will also realize that the customer may be the called or calling party. Furthermore, only the network elements needed to describe the present invention are illustrated in FIG. 2. It is not intended to show all the network components or connectivity needed to provide VoIP or SoIP services.

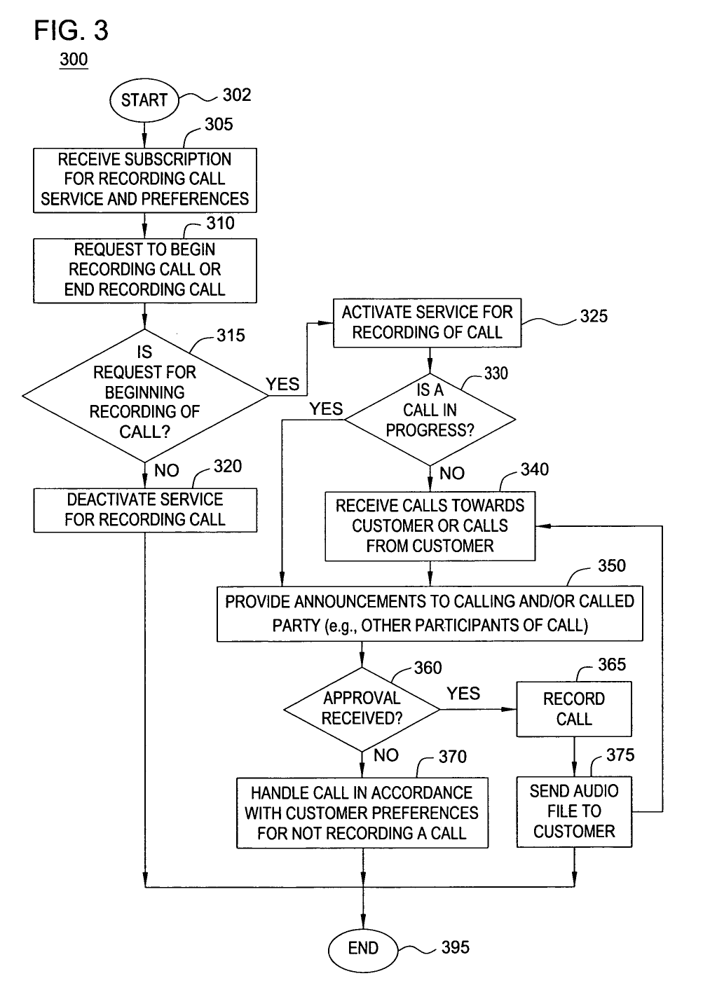

FIG. 3 illustrates a flowchart of the method 300 for providing a service for recording calls. For example, a service provider may provide the service for recording calls on an application server, where a customer or subscriber may provide preferences as to how such call recording will be conducted. For example, the service provider may provide touchtone numbers for beginning and ending the recording. In another example, the customer may access a web site and change a current recording status.

Method 300 starts in step 302 and proceeds to step 305. In step 305, method 300 receives a subscription from a customer for a recording call service and preferences associated with such recording service. For example, a customer subscribing to the service may provide preferences for actions that will be taken to obtain approval from the parties to be recorded. For example, the customer may choose to request an acknowledgement or an agreement from the parties on the call to be recorded or may simply notify the other party that the call is being recorded. In turn, the person may choose to agree or to disagree to the recording, e.g., via predefined DTMF signals.

The customer preference may also include options for storing audio files, preferred announcements to calling and/or called parties, etc. For example, the customer may prefer to retrieve the audio files from a network location as needed or may prefer to automatically receive the audio files as email attachments. In another example, the service provider may enable the customer to specify whether all calls, only incoming calls, only outgoing calls, etc. are to be recorded. The service provider determines the optional preferences to be offered to the customer.

In step 310, method 300 receives a request from the customer to begin recording calls or to end recording of calls. For example, a customer may activate the recording of call service via a predefined touchtone signal, e.g., dialing “111” to start recording and “222” to stop recording and so on.

In step 315, method 300 determines whether or not the request is to begin recording of a call. If the request is to begin recording of a call, then the method proceeds to step 325 to activate the service of recording of the call. If the request is to end recording of the call, the method proceeds to step 320 to deactivate the service of recording of the call.

In step 320, method 300 deactivates the service for recording of the calls. For example, the application server and/or media server for the recording service can be removed from the path of the call packets. The method then proceeds to step 395 to end processing the current request.

In step 325, method 300 activates the call recording service. For example, one or more calls can be routed through the application server and/or media server providing the call recording service. It should be noted that the call is actually not being recorded in this step, but the process of recording the call is initiated at this step. Namely various network resources are activated or brought on-line for supporting the recording service.

In step 330, method 300 determines whether or not there is a call in progress. If there is no call in progress, the method proceeds to step 340 to handle subsequent calls. If there is a call in progress, then the method proceeds to step 350.

In step 340, method 300 waits for calls directed from the customer or directed towards the customer. Namely, since a call is currently not in progress, the activation of the recording service is for subsequent calls directed from and/or towards the customer. Thus, the customer may either be the calling party or called party. In one embodiment, calls originated or received after the service is activated are established through the application server providing the service for recording calls.

In step 350, method 300 provides announcements, e.g., prerecorded announcements, to the calling and/or called party. The announcement may include notifying the other participant(s) of the request from the customer to record the current conversation. In one embodiment, the media server is used to interact with the called and/or calling parties and to receive acknowledgement or approval for the recording action. For example, the pre-recorded announcement may comprise: “The called (or calling) party has requested that this call be recorded. Please provide acceptance of this request by pressing ‘1’ or decline acceptance of this request by pressing ‘0’”.

In step 360, method 300 determines whether or not the calling or called party (e.g., the other participant(s) on the call) agreed to the recording. If an acceptance or acknowledgement is received, the method proceeds to step 365 to record the current call. Otherwise, the method proceeds to step 370. In one embodiment, the acceptance or denial provided by the other participant(s) is made known to the customer, so that the customer is made aware of whether the current call will be recorded or not.

In step 365, method 300 records the current call. When the call is finished (or a signal, e.g., a predefined DTMF signal, is received from the customer to terminate the recording), an audio file of the recorded conversation is generated and saved, such that the audio file can be accessed by the customer, e.g., via a web interface or is automatically forwarded to the customer, e.g., in an email as an attachment.

In step 375, method 300 optionally sends the audio files to the customer. For example, the customer may specify an email address for receiving the audio files. The customer may also prefer retrieving the audio files from a network location when needed. The method then proceeds to step 395 to end processing the current request (or alternatively to return to step 340 to wait for other calls).

In step 370, method 300 handles a call in accordance with customer preferences for calls that have not received approval from the other participant(s) for recording the call. For example, a customer may decide to terminate the call or to even stop the call from being completed (e.g., if the call is an inbound call to the customer, a non-acceptance will cause the inbound call to be terminated without ever connecting the calling party to the customer). Alternatively, the customer may simply proceed with the call without the recording feature being activated. In one embodiment, the method may alert the customer via an pre-recorded announcement of the fact that the call is not being recorded and then the call may proceed. Method 300 ends in step 395.

Those skilled in the art will realize that multiple requests and calls may be processed simultaneously, e.g., a customer may have one call on one line being recorded, while another call on another line is not being recorded. Furthermore, the order of steps of FIG. 3 is only illustrative is not intended to limit the present invention.

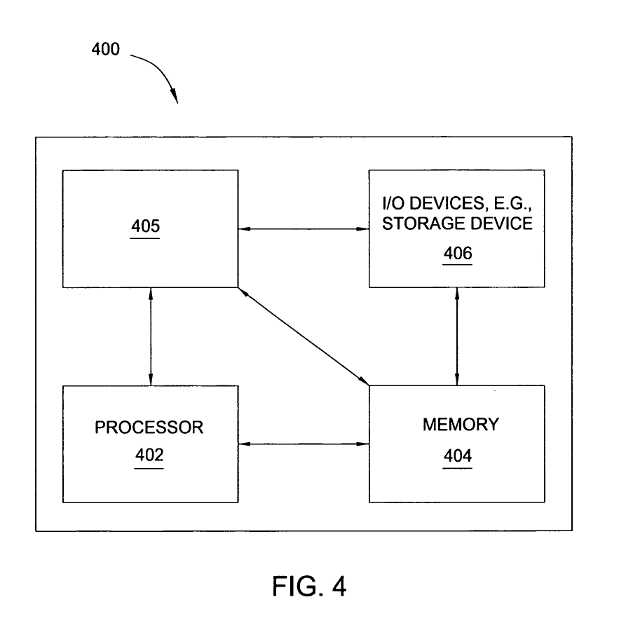

FIG. 4 depicts a high-level block diagram of a general-purpose computer suitable for use in performing the functions described herein. As depicted in FIG. 4, the system 400 comprises a processor element 402 (e.g., a CPU), a memory 404, e.g., random access memory (RAM) and/or read only memory (ROM), a module 405 for providing a service for recording calls, and various input/output devices 406 (e.g., storage devices, including but not limited to, a tape drive, a floppy drive, a hard disk drive or a compact disk drive, a receiver, a transmitter, a speaker, a display, a speech synthesizer, an output port, and a user input device (such as a keyboard, a keypad, a mouse, alarm interfaces, power relays and the like)).

It should be noted that the present invention can be implemented in software and/or in a combination of software and hardware, e.g., using application specific integrated circuits (ASIC), a general-purpose computer or any other hardware equivalents. In one embodiment, the present module or process 405 for providing a service for recording calls can be loaded into memory 404 and executed by processor 402 to implement the functions as discussed above. As such, the present method 405 for providing a service for recording calls (including associated data structures) of the present invention can be stored on a computer readable medium or carrier, e.g., RAM memory, magnetic or optical drive or diskette and the like.

While various embodiments have been described above, it should be understood that they have been presented by way of example only, and not limitation. Thus, the breadth and scope of a preferred embodiment should not be limited by any of the above-described exemplary embodiments, but should be defined only in accordance with the following claims and their equivalents.

What is claimed is:

1. A method for providing a service for recording a call in a communication network, comprising:
receiving a request to record a call between a subscriber and at least one participant;
presenting an announcement to said at least one participant that said call is to be recorded; and
recording said call if an acceptance is received from said at least one participant to allow said call to be recorded.

2. The method of claim 1, wherein said communication network is a Voice over Internet Protocol (VoIP) network or a Service over Internet Protocol (SoIP) network.

3. The method of claim 1, wherein said subscriber is a calling party or a called party to said call.

4. The method of claim 1, wherein said announcement is provided by a media server.

5. The method of claim 4, wherein said announcement is a pre-recorded announcement requesting said at least one participant to provide said acceptance.

6. The method of claim 1, wherein said acceptance is received as a Dual Tone Multi Frequency (DTMF) signal.

7. The method of claim 1, wherein said request to record said call is received as a Dual Tone Multi Frequency (DTMF) signal.

8. The method of claim 1, wherein said request to record said call is received as an input via a web interface.

9. The method of claim 1, further comprising:
recording said call into an audio file, where said audio file is forwarded to said subscriber via an email.

10. A computer-readable medium having stored thereon a plurality of instructions, the plurality of instructions including instructions which, when executed by a processor, cause the processor to perform the steps of a method for providing a service for recording a call in a communication network, comprising:
receiving a request to record a call between a subscriber and at least one participant;
presenting an announcement to said at least one participant that said call is to be recorded; and
recording said call if an acceptance is received from said at least one participant to allow said call to be recorded.

11. The computer-readable medium of claim 10, wherein said communication network is a Voice over Internet Protocol (VoIP) network or a Service over Internet Protocol (SoIP) network.

12. The computer-readable medium of claim 10, wherein said subscriber is a calling party or a called party to said call.

13. The computer-readable medium of claim 10, wherein said announcement is provided by a media server.

14. The computer-readable medium of claim 13, wherein said announcement is a pre-recorded announcement requesting said at least one participant to provide said acceptance.

15. The computer-readable medium of claim 10, wherein said acceptance is received as a Dual Tone Multi Frequency (DTMF) signal.

16. The computer-readable medium of claim 10, wherein said request to record said call is received as a Dual Tone Multi Frequency (DTMF) signal.

17. The computer-readable medium of claim 10, wherein said request to record said call is received as an input via a web interface.

18. The computer-readable medium of claim 10, further comprising:
recording said call into an audio file, where said audio file is forwarded to said subscriber via an email.

19. An apparatus for providing a service for recording a call in a communication network, comprising:
means for receiving a request to record a call between a subscriber and at least one participant;
means for presenting an announcement to said at least one participant that said call is to be recorded; and
means for recording said call if an acceptance is received from said at least one participant to allow said call to be recorded.

20. The apparatus of claim 19, wherein said announcement is provided by a media server.
